(19) United States
(12) Patent Application Publication
(10) Pub. No.: US 2021/0224743 A1
(43) Pub. Date: Jul. 22, 2021

(54) METHOD, DEVICE, USER TERMINAL AND STORAGE MEDIUM OF QUERYING STATUS OF ELECTRONIC POLICY

(71) Applicant: PING AN TECHNOLOGY (SHENZHEN) CO., LTD., Shenzhen, Guangdong (CN)

(72) Inventors: Jie ZHANG, Shenzhen, Guangdong (CN); Xue GAO, Shenzhen, Guangdong (CN); Bin LI, Shenzhen, Guangdong (CN); Jie CHEN, Shenzhen, Guangdong (CN); Zhengbo SHAO, Shenzhen, Guangdong (CN); Xiangdong MA, Shenzhen, Guangdong (CN); Jie DING, Shenzhen, Guangdong (CN)

(73) Assignee: PING AN TECHNOLOGY (SHENZHEN) CO., LTD., Shenzhen, Guangdong (CN)

(21) Appl. No.: 16/097,992

(22) PCT Filed: Feb. 26, 2018
(86) PCT No.: PCT/CN2018/077212

§ 371 Date: Oct. 31, 2018

(30) Foreign Application Priority Data
Jul. 25, 2017 (CN) 20170613849.X

(51) Int. Cl. G06Q 10/10; G06F 16/245; G06F 16/248; G06Q 40/08; G06Q 30/00

(52) U.S. Cl. CPC G06Q 10/10; G06F 16/245; G06Q 30/0185; G06Q 40/08; G06F 16/248

(57) ABSTRACT

A method of querying a status of an electronic insurance policy includes: receiving an inputted policy number; querying an initial status and an operation flow set of the electronic insurance policy corresponding to the policy number when the policy number is a valid policy number; obtaining a mapped status subset according to a status total set to which the initial status belongs and a status that each operation flow in the operation flow set is mapped in the status total set; and displaying the initial status of the electronic insurance policy and the obtained status subset.

### CROSS-REFERENCE TO RELATED APPLICATION

This application claims priority to Chinese Patent Application No. 201710613849X, entitled “METHOD, DEVICE, USER TERMINAL AND STORAGE MEDIUM OF QUERYING STATUS OF ELETRONIC POLICY” filed to the State Intellectual Property Office on Jul. 25, 2017, the contents of which is expressly incorporated by reference herein in its entirety.

### TECHNICAL FIELD

The present application relates to the field of computer technologies, and in particular, relates to a method, a device user terminal, and a storage medium of querying a status of an electronic insurance policy.

### BACKGROUND

In the insurance field, the operation flow of the policy and the status of the user's electronic insurance policy can only be seen by authorized employees within the insurance company. When a customer needs to know the latest or past status of the insurance they have purchased, they can only ask the authorized staff in the insurance company, which is very inconvenient to customers.

So far, there is no convenient and intuitive way yet to allow customers a quick understanding of the various statuses of their insurance policies.

### SUMMARY

According to various embodiments of the present application, a method, a device, a user terminal, and a storage medium of querying a status of an electronic insurance policy are provided.

A method of querying a status of an electronic insurance policy includes: receiving an inputted policy number; querying an initial status and an operation flow set of the electronic insurance policy corresponding to the policy number when the policy number is a valid policy number; obtaining a mapped status subset according to a status total set to which the initial status belongs and a status that each operation flow in the operation flow set is mapped in the status total set; and displaying the initial status of the electronic insurance policy and the obtained status subset.

A device of querying a status of an electronic insurance policy, the device includes: a policy number receiving module configured to receive an inputted policy number; a querying module configured to query an initial status and an operation flow set of the electronic insurance policy corresponding to the policy number when the policy number is a valid policy number; a status obtaining module configured to obtain a mapped status subset according to a status total set to which the initial status belongs and a status that each operation flow in the operation flow set is mapped in the status total set; and a status displaying module configured to display the initial status of the electronic insurance policy and the obtained status subset.

A user terminal including one or more processors and a memory having computer-readable instructions stored therein that, when executed by the processor, cause the one or more processes to perform the following steps: receiving an inputted policy number; querying an initial status and an operation flow set of the electronic insurance policy corresponding to the policy number when the policy number is a valid policy number; obtaining a mapped status subset according to a status total set to which the initial status belongs and a status that each operation flow in the operation flow set is mapped in the status total set; and displaying the initial status of the electronic insurance policy and the obtained status subset.

One or more non-transitory readable storage medium having computer-readable instructions stored thereon that, when executed by one or more processors, cause the one or more processors to perform the following steps: receiving an inputted policy number; querying an initial status and an operation flow set of the electronic insurance policy corresponding to the policy number when the policy number is a valid policy number; obtaining a mapped status subset according to a status total set to which the initial status belongs and a status that each operation flow in the operation flow set is mapped in the status total set; and displaying the initial status of the electronic insurance policy and the obtained status subset.

The details of one or more embodiments of the present application are set forth in the accompanying drawings and the description below. Other features, objects, and advantages of the application will be apparent from the description and drawings, and from the claims.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a flowchart of a method of querying a status of an electronic insurance policy according to an embodiment;

FIG. 2 is a flowchart of a method of querying a status of an electronic insurance policy according to another embodiment;

FIG. 3 is a flowchart of a method of querying a status of an electronic insurance policy according to yet another embodiment;

FIG. 4 is an exemplary block diagram of a device of querying a status of an electronic insurance policy according to an embodiment;

FIG. 5 is an exemplary block diagram of a device of querying a status of an electronic insurance policy according to another embodiment;

FIG. 6 is an exemplary block diagram of a user terminal according to an embodiment.

### DETAILED DESCRIPTION OF THE EMBODIMENTS

The present disclosure will be described in details in combination with the accompanying drawings and embodiments such that the purpose, technical solution and advantages of the present disclosure will be more apparent. It should be understood that the particular embodiments are described for the purpose of illustrating as opposed to restricting the present disclosure.

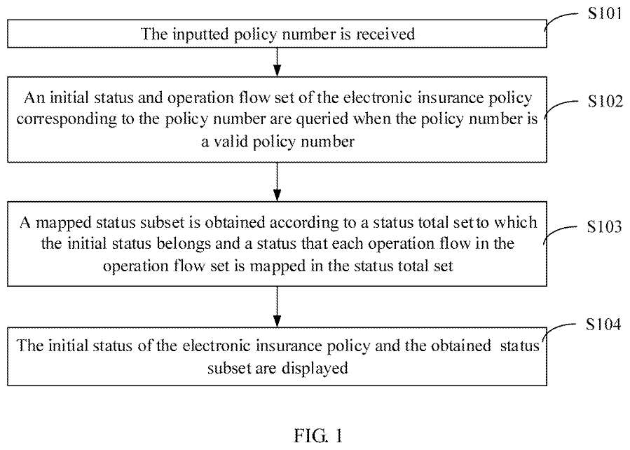

FIG. 1 is a flowchart of a method of querying a status of an electronic insurance policy according to an embodiment of the present disclosure. The method of querying a status of an electronic insurance policy according to an embodiment of the present application is described in detail below with reference to FIG. 1. As shown in FIG. 1, the method of querying a status of an electronic insurance policy includes the following steps S101, S102, S103, and S104.

S101: The inputted policy number is received.

According to an embodiment of the present disclosure, the input operation of the policy number may be performed by a user. Further, the user may be the applicant of the policy (the applicant refers to the person who purchased the policy corresponding to the policy number). The user may also be the insured person of the policy (the insured person is the beneficiary of the insurance when the claim is settled), or the user may be an authorized staff within the insurance company. The input method may be a manually inputting by way of touching a soft keyboard, an inputting through the microphone to recognize the user's inputted voice content, may also be a manually inputting through a physical keyboard connected to the user terminal, or may be a source of input by way of scanning a barcode carrying information or QR code automatic identification. In the case of the scanned input, the following steps 1 and 2 are specifically included:

1. the barcode or QR code carrying the policy number information is scanned;

2. the policy number identified in the barcode or QR code is regarded as the inputted policy number.

In the foregoing step 1, the barcode or QR code carrying the policy number information may be a label with a barcode or a two-dimensional code pasted on a paper policy or other object, and the barcode or QR code is presented on the label or other object by printing or manually drawing.

S102: An initial status and operation flow set of the electronic insurance policy corresponding to the policy number are queried when the policy number is a valid policy number.

According to an example of this embodiment, the foregoing approach to determine whether the policy number is a valid policy number of the electronic insurance policy may be: comparing the received policy number with a pre-stored valid policy number of an electronic insurance policy in the system, if a policy number that is the same as the received policy number exists among the pre-stored valid policy numbers of the electronic insurance policy, the received policy number is determined to be a valid policy number of the electronic insurance policy. The electronic insurance policy is distinguished from the policy of the paper contract type and refers to the insurance policies stored in the system in the form of files.

According to another example of this embodiment, the initial status is a status stored in advance when the electronic insurance policy is generated, and the operation flow set stores the operation flows when the electronic insurance policy status is subsequently changed, and the operation flow includes but is not limited to whether the electronic insurance policy is paid, whether the insurer of the electronic insurance policy is changed, whether the electronic insurance policy is underwritten, whether the electronic insurance policy is returned, and so on. The storing manner of each operation flow in the operation flow set in the user terminal or the server is to store preset characters representing the operation flow. According to a usage scenario of the present embodiment, for example, the characters indicating the operation flow of payment are AA, the characters indicating the operation flow of underwriting are BB, and the characters indicating the operation flow of returned are CC, and the characters indicating the operation flow of claim settlement are DD. If the operation flow set of the electronic insurance policy is {AA, BB, DD}, it suggests that the electronic insurance policy is paid, underwritten, and claim settled.

S103: a mapped status subset is obtained according to a status total set to which the initial status belongs and a status that each operation flow in the operation flow set is mapped in the status total set.

According to an example of this embodiment, all statuses that may be experienced by an electronic insurance policy are stored in the status total set, including but not limited to electronic insurance policy, not electronic insurance policy, paid, not paid, underwritten, not underwritten, claim settled, claim not settled, and so on. According to another example of this embodiment, a status code indicating a corresponding status is preset for each status, and the status total set has such a status code stored therein; the method further includes the following steps a and b:

a. A status set of the mapped status code is obtained according to the status total set to which the status code of the initial status belongs and the status code that each operation flow in the operation flow set is mapped in the status total set.

b. A status represented by the status code in the obtained status subset is displayed.

According to a usage scenario of the present embodiment, the foregoing status total set includes “electronic insurance policy, not electronic insurance policy, paid, not paid, underwritten, not underwritten, claim settled, claim not settled, and so on”. The preset status codes for the status total set are respectively and sequentially {01, 02, 03, 04, 05, 06, 07, 08}, for example, the initial status of the electronic insurance policy is an electronic insurance policy, and the preset status code corresponding to the electronic insurance policy is 01. The pre-stored operation flow set corresponding to the electronic insurance policy is {AA, BB, DD}. According to the preset mapping relationships AA-03, BB-05, and DD-07, the obtained status subset of the electronic insurance policy, after mapping, is {03, 05, 07}. And according to the status represented by the preset status code, it can be learned that the initial status of the electronic insurance policy corresponding to the status is electronic insurance policy, and the mapped status are “paid, underwritten, and claim settled”.

S104: The initial status of the electronic insurance policy and the obtained status subset are displayed.

Following up with the foregoing usage scenario in step S103, the usage scenario of step S104 is to display the initial status “electronic insurance policy” and the mapped status subset “paid, underwritten, and claim settled”.

In order to protect the privacy of the applicant, according to an embodiment of the present disclosure, prior to the step of step S104, it also includes verifying the identity of the user having the status of viewing the policy, which specifically includes the following steps:

1. Pre-stored password and/or user identity information bound to the policy number is/are queried;

2. Inputted Password and/or user identity information is/are received;

3. When the pre-stored verification method bound with the policy number includes password, the received password is compared with the pre-stored password, if the comparison result is the same, the verification is determined to be successful; when the pre-stored verification method bound with the policy number includes user identity information, the received user identity information is matched with the pre-stored user identity information, when the matching is successful, the verification is determined to be successful.

4. When the password and/or user identity information verification is/are successful, it is determined that the user is authorized to view the policy status corresponding to the policy number, and then the initial status of the electronic insurance policy and the obtained status subset are displayed.

According to an example of this embodiment, when only the password is pre-stored, the password inputted by the user is verified. If the password inputted by the user is correct, the verification is successful. When the user identity information is pre-stored, the identity information inputted by the user is verified. When the identity information inputted by the user is matched i.e., the verification is successful.

When the above two verification methods are pre-stored, the password as well as the identity information inputted by the user are required to be verified at the same time. When the password inputted by the user is correct and the identity information inputted by the user matches with the pre-stored identity information, it is determined that the verification is successful.

The foregoing and/or relation can be understood as: when pre-stored password as well as user identity information are bound to the policy number, the “and/or” in the subsequent steps 2 and 4 can both be “and” and can both be “or” at the same time. When it is “or” at the same time, if received in step 2 is password inputted by the user, then it can be determined in step 3 whether the verification is successful by comparing the received password with the pre-stored password. In step 4, the “when the password and/or user identity information verification is successful, it is determined that the user is authorized to view the policy status corresponding to the policy number” is “when the password verification is successful, it is determined that the user is authorized to view the policy status corresponding to the policy number”; if received in step 2 is user identity information, then in step 3, it can be determined whether the verification is successful by comparing the received user identity information with the pre-stored user identity information. In step 4, the “when the password and/or user identity information verification is/are successful” is “when the foregoing user identity information verification is successful”; when it is understood as “and”, it suggests that it is required to verify the password as well as the user identity information at the same time, and the “and/or” in both steps 2 and 4 should be understood as “and”.

According to an example of the embodiment, the pre-stored password and the user identity information may be stored at the local end, or may be stored in the server. When the pre-stored password and the user identity information are stored in the server, after the step of receiving the inputted password and/or user identity information, further includes:

The received password and/or user identity information is/are sent to the server.

According to an example of the embodiment, the foregoing steps S102, S103 and the foregoing step 3 are performed by a server, and the step 4 further includes:

When the password and/or the user identity information is/are successfully verified at the server, the user is determined to have the status of viewing the status of the policy corresponding to the policy number, and the server sends the initial status of the electronic insurance policy and the obtained status subset to the local end user terminal.

The user terminal displays the initial status of the received electronic insurance policy and the obtained status subset.

According to another example of the embodiment, the forms of the foregoing password includes, but is not limited to, all digits, all letters, a combination of capital and lowercase letters, a combination of digits and capital and lowercase letters, and so on. The foregoing user identity information includes, but is not limited to, user fingerprint, lip print, iris, facial features, and so on.

In this embodiment, the initial status of the policy is queried according to the inputted policy number by the user, and according to the stored operation flow set of the policy, the status subset queried in the status total set and belonging to the policy is displayed, so that the user can query the initial status, the intermediate status, and the latest status of the electronic insurance policy according to the policy number of the electronic insurance policy, so that the user can learn the status of the electronic insurance policy in real time.

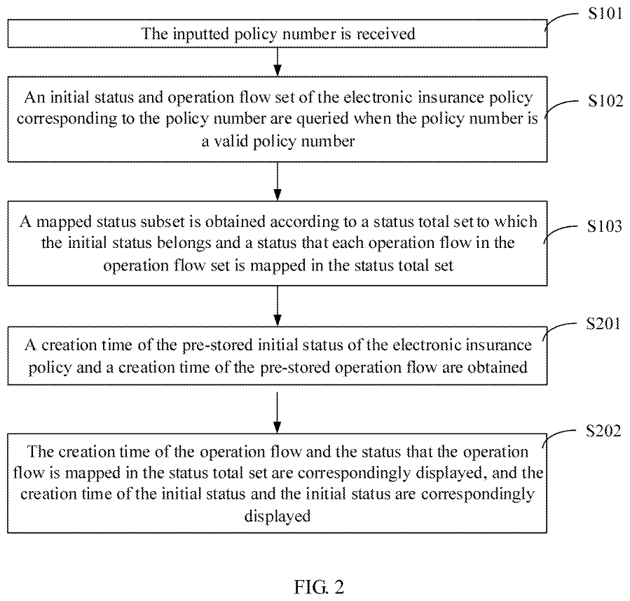

FIG. 2 is a flowchart of a method of querying a status of an electronic insurance policy according to another embodiment of the present disclosure. The method of querying a status of an electronic insurance policy as shown in FIG. 2, which, in addition to the foregoing steps of S101, S102, and S103, further includes:

S201: A creation time of the pre-stored initial status of the electronic insurance policy and a creation time of the pre-stored operation flow are obtained.

The specific step of the above step S104 is step S202:

S202: The creation time of the operation flow and the status that the operation flow is mapped in the status total set are correspondingly displayed, and the creation time of the initial status and the initial status are correspondingly displayed.

According to an example of the embodiment, prior to the step of step S104 or S202, the method further includes:

Whether the operation flow set comprises a return is determined;

a mapped status subset is obtained according to a status that each operation flow in the operation flow set is mapped in the status total set, when the operation flow set does not include the return.

To follow up with the usage scenario in the foregoing step S103, according to a usage scenario of the embodiment, for example, when the user inputs the electronic insurance policy in the system, the system regards the inputted time (for example, 2017/5/10) as the creation time of the initial status of the electronic insurance policy, and the time of input is stored in correspondence with the initial status in a form, for example, as “S0:2017/5/10”, S0 is the initial status, and when the information of paid is inputted by the user, the system will regard the input time (for example, 2017/5/12) or the time inputted by the user (for example, 2017/5/11) as the time paid. According to an example of the embodiment, when a time of paid inputted by the user is received, the inputted time of paid will be regarded as the time of actual payment and stored in the form of, for example, “AA:2017/5/11”. The inputted time of the underwriting is 2017/5/16, and the inputted time by the recorder of the underwriting is 2017/5/15, the system regards and stores the time of underwriting inputted by recorder as the time of underwriting in a form, for example, as “BB:2017/5/15”. Similarly, the system regards the claim time inputted by the recorder as the stored claim time which is, for example, 2017/5/31, and stored as, for example, “DD: 2017/5/31”. Based on this scenario, it can be concluded that the creation time of the pre-stored initial status of the electronic insurance policy is {{01:2017/5/10)} and the creation time of respective operation flows are {(AA:2017/5/11), (BB:2017/5/15), (DD:2017/5/31)}, according to the mapping relation mapped in the status total set of each operation flow in the operation flow set {AA, BB, DD} the obtained status subsets are {(03:2017/5/11), (05:2017/5/15), (07:2017/5/31)}. According to an example of the embodiment, the display manner of the foregoing step S202 is:

Electronic insurance policy: 2017/5/10;

Paid: 2017/5/11;

Underwritten: 2017/5/15;

Claim settled: 2017/5/31.

This embodiment obtains and displays the creation time of the user policy status, so that the user can further understand the status of the electronic insurance policy and improve the user experience.

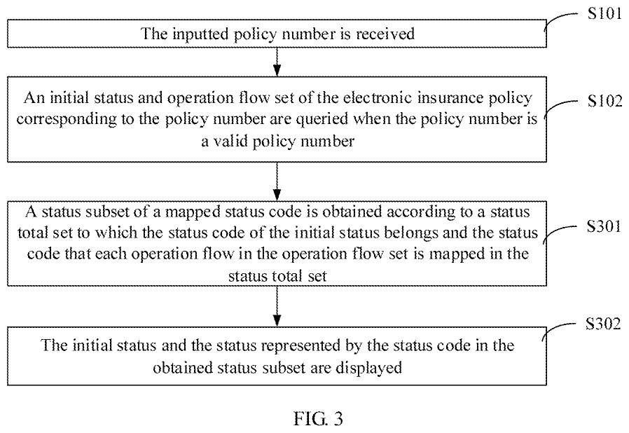

FIG. 3 is a flowchart of a method of querying a status of an electronic insurance policy according to yet another embodiment of the present disclosure. The method of querying a status of an electronic insurance policy as shown in FIG. 3, in addition to that the method includes the foregoing steps of S101, S102, the step S103 further is S301, and the foregoing step S104 further is step S302.

S301: a status subset of a mapped status code is obtained according to a status total set to which the status code of the initial status belongs and the status code that each operation flow in the operation flow set is mapped in the status total set.

According to an example of this embodiment, the foregoing status total includes two total sets, which are respectively the status total set M of the electronic policies: {01, 02, 03, 04, 05, 06, 07, 08} and the status total set of the non-electronic insurance policy N: {21, 22, 23, 24, 25}, if the initial status of the policy corresponding to the received policy number is 01, since 01 belongs to the status total set M, M may be selected as the status total set corresponding to the received policy number. If the operation flow set is {AA, BB, DD}, where AA, BB, and DD respectively represent different operation flows, and the mapping relations of the preset operation flow set and respective statuses in the status total set M are AA-03, BB-05, DD-07, then the status subset of the mapped status total set M is {03, 05, 07}.

S302: The initial status and the status represented by the status code in the obtained status subset are displayed.

According to a usage scenario of this embodiment, according to the status represented by the above status code: 03 means paid, 05 means underwritten, 07 means claim settled, and statuses of “electronic insurance policy, paid, underwritten, and claim settled” are shown.

According to an example of the embodiment, the steps S101 and S302 can be performed by the user terminal, and the steps S102 and S301 can be performed by the user terminal or by the server. When the step S102 and the step S301 are performed by the server, after the foregoing step S101 are performed, further includes: the received policy number is transmitted to the server.

Prior to the step S302, the method further includes step: the initial status of the electronic insurance policy corresponding to the queried policy number and the status corresponding to the obtained status code are transmitted to the user terminal.

The foregoing step S302 further is: the initial status and the status represented by the status code in the obtained status subset are displayed through the display screen of the user terminal.

This embodiment provides a method for a user terminal or a server to implement the storing of an initial status, a status total set, a status subset, and an operation flow set involved in a method of querying a status of an electronic insurance policy that involves an initial status, a status total set, a status subset and operation flow set, so that the system can store statuses and process operations with convenience.

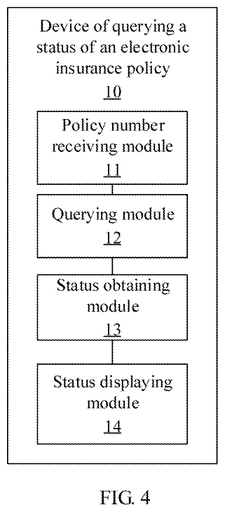

FIG. 4 is an illustrative block diagram of a device of querying a status of an electronic insurance policy according to an embodiment of the present disclosure. The device of querying a status of an electronic insurance policy according to an example of the present embodiment will be described in detail with reference to FIG. 4. As shown in FIG. 4, the device of querying a status of an electronic insurance policy 10 includes a policy number receiving module 11 configured to receive the inputted policy number, and a querying module 12 configured to query the initial status and operation flow set of the electronic insurance policy corresponding to the policy number when the policy number is a valid policy number; the status obtaining module 13 is configured to obtain the mapped status subset according to the status total set to which the initial status belongs and the status that each operation flow in the operation flow set is mapped in the status total set; the status displaying module 14 is configured to display an initial status of the electronic insurance policy and the obtained status subset.

In order to protect the privacy of the applicant, according to an embodiment of the present application, the device of querying a status of an electronic insurance policy 10 further includes: an inquiry unit configured to query a pre-stored password and/or user identity information bound to the policy number; a receiving unit configured to receive the inputted password and/or the user identity information; a verification unit configured to compare the received password with the pre-stored password when the pre-stored verification method bound to the policy number includes password. If the comparison result is same, the verification is determined to be successful; when the pre-stored verification method bound to the policy number includes user identity information, the received user identity information is matched with the pre-stored user identity information, when the matching is successful, it is determined that the verification is successful.

The foregoing status displaying module 14 is further configured to determine that the user has the status of viewing the policy corresponding to the policy number when the password and/or user identity information verification is/are successful, and then the initial status and obtained status subset of the electronic insurance policy are displayed.

The foregoing and/or relation can be understood as: when pre-stored password as well as user identity information are bound to the policy number, the “and/or” in the subsequent steps 2 and 4 can both be “and” and can both be “or” at the same time. When it is “or” at the same time, if received in step 2 is password inputted by the user, then it can be determined in step 3 whether the verification is successful by comparing the received password with the pre-stored password. In step 4, the “when the password and/or user identity information verification is successful” is “when the password verification is successful”; if received in step 2 is the user identity information, then in step 3, it can be determined in whether the verification is successful by comparing the received user identity information with the pre-stored user identity information. In step 4, the “when the password and/or user identity information verification is successful” is “when the foregoing user identity information verification is successful”; when it is understood as “and”, it suggests that it is required to verify the password as well as the user identity information at the same time, and the “and/or” in both steps 2 and 4 should be understood as “and”.

According to an example of the present embodiment, when the foregoing querying module and status obtaining module are included on the server end, the device of querying a status of an electronic insurance policy 10 further includes: a transmission unit included in the local terminal and configured to transmit the received password and/or user identity information to the server. A status subset receiving unit included in the local end is configured to determine that the user has the status of viewing the policy corresponding to the policy number when the password and/or the user identity information are successfully verified on the server. And the server will transmit the initial status and the obtained status subset to the local end user terminal; a policy number transmission unit included in the local end and configured to send the received policy number to the server. A status code receiving unit included in the local terminal and configured to send the initial status of the electronic insurance policy corresponding to the policy number and the status corresponding to the obtained status code to the user terminal.

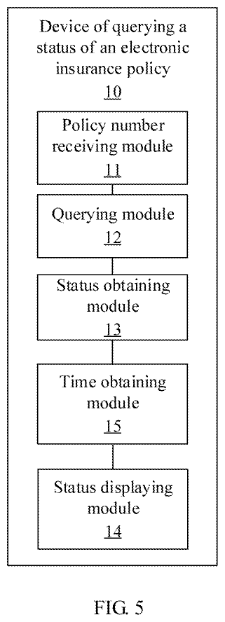

FIG. 5 is an illustrative block diagram of a device of querying a status of an electronic insurance policy according to another embodiment of the present disclosure. According to an embodiment of the present disclosure, as shown in FIG. 5, the device of querying a status of an electronic insurance policy, in addition to including the foregoing policy number receiving module 11, the querying module 12, the status obtaining module 13, and the status displaying module 14, on account of that the creation time of each operation flow is stored in the operation flow in the foregoing operation flow set, the device of querying a status of an electronic insurance policy 10 further includes: a time obtaining module 15 configured to obtain a creation time of the pre-stored initial status of the electronic insurance policy and a creation time of the pre-stored operation flow; the status displaying module 14 is further configured to correspondingly display the creation time of the operation flow and the status that the operation flow is mapped in the status total set, and correspondingly display the creation time of the initial status and the initial status.

According to another example of the embodiment, the device of querying a status of an electronic insurance policy 10 further includes: a scanning module configured to scan a barcode or a QR code carrying the policy number information; the policy number receiving module is further configured to regard the policy number identified in the barcode or QR code as the inputted policy number.

Further, the device of querying a status of an electronic insurance policy 10 further includes: a determining module configured to determine whether the operation flow set includes a return; the foregoing status obtaining module 13 is further configured to obtain a mapped status subset according to a status that each operation flow in the operation flow set is mapped in the status total set, when the operation flow set does not include the return.

Further, the above status obtaining module 13 includes a status code obtaining unit configured to obtain a status subset of a mapped status code according to the status total set to which the status code of the initial status belongs and the status code that each operation flow in the operation flow set is mapped in the status total set; the foregoing status displaying module 14 is further configured to display the status represented by the status code in the obtained status subset.

According to a usage scenario of the present embodiment, for example, the characters indicating the operation flow of payment are AA, the characters indicating the operation flow of underwriting are BB, and the characters indicating the operation flow of returned are CC, and the characters indicating the operation flow of claim settlement are DD. If the operation flow set of the electronic insurance policy is {AA, BB, DD}, it suggests that the electronic insurance policy is paid, underwritten, and claim settled. The foregoing status total set includes “electronic insurance policy, not electronic insurance policy, paid, not paid, underwritten, not underwritten, claim settled, claim not settled”. The successive preset status codes in the status total set are respectively {01, 02, 03, 04, 05, 06, 07, 08}. For example, the initial status of the electronic insurance policy is an electronic insurance policy, and the preset status code corresponding to the electronic insurance policy is 01. The pre-stored operation flow set corresponding to the electronic insurance policy is {AA, BB, DD}. According to the preset mapping relations AA-03, BB-05, and DD-07, the obtained status subset of the electronic insurance policy after mapping is {03, 05, 07}. Then, according to the status represented by the preset status code, it can be learned that the initial status of the electronic insurance policy corresponding to the status is an electronic insurance policy, and the mapped status is “paid, underwritten, and claim settled”. The status displaying module is configured to display the initial status “electronic insurance policy” and the mapped status subset “paid, underwritten, and claim settled”.

When the user inputs the electronic insurance policy in the system, the system regards the inputted time (for example, 2017/5/10) as the creation time of the initial status of the electronic insurance policy, and the time of input is stored in correspondence with the initial status in a form, for example, as “S0:2017/5/10”, S0 is the initial status, and when the information of payment made is inputted by the user, the inputted time of paid is, for example, 2017/5/11, the storage form which the creation time of the operation flow corresponds the operation flow is, for example, “AA:2017/5/11”, the inputted time of underwriting is 2017/5/16, the time of underwriting inputted by the recorder is 2017/5/15, the system regards and stores the time of underwriting inputted by the recorder as the time of underwriting in a form as, for example “BB: 2017/5/15”. Similarly, the system regards the claim time inputted by the recorder as the stored claim time which is, for example, 2017/5/31, and stored as, for example, “DD: 2017/5/31”. Based on this scenario, it can be concluded that the creation time of the pre-stored initial status of the electronic insurance policy is {(01:2017/5/10)} and the creation time of respective operation flows are {(AA:2017/5/11), (BB:2017/5/15), (DD:2017/5/31)}, according to the mapping relation mapped in the status total set of each operation flow in the operation flow set {AA, BB, DD} the obtained status subsets are {(03:2017/5/11), (05:2017/5/15), 07:2017/5/31)}. According to an example of the embodiment, the creation time of each operation flow and the creation time of the initial status are obtained by the foregoing time obtaining module 15, and the display manner of the foregoing status displaying module is:

Electronic insurance policy: 2017/5/10;

Paid: 2017/5/11;

Underwritten: 2017/5/15;

Claim settled: 2017/5/31.

Reference can be made to foregoing limitations of the method of querying a status of an electronic insurance policy for the specific limitations of the device of querying a status of an electronic insurance policy, which will not be described here. The various modules of the foregoing device of querying a status of an electronic insurance policy can be implemented, in part or as a whole, by software, hardware or the combinations thereof The foregoing modules can be embedded in or independent from the processor of a user terminal and in the form of hardware, or be stored in a memory of user terminal and in the form of software, so as to facilitate the processor to call and execute corresponding operations of the foregoing various modules.

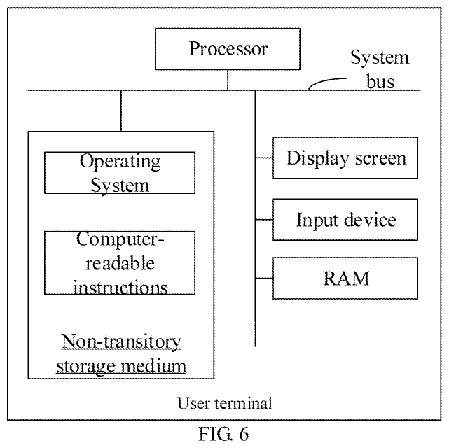

As shown in FIG. 6, which is an illustrative block diagram of the user terminal according to an embodiment of the present disclosure, the user terminal includes a processor, a non-transitory storage medium, a RAM, a display screen and an input device connected through the system bus. The non-transitory storage medium of the user terminal may store an operating system and computer-readable instructions which, when executed, can cause the processor to perform a method of querying a status of an electronic insurance policy according to various embodiments of the present disclosure. For the specific implementation process of the method, reference may be made to the specifics of the embodiments in FIG. 1 to FIG. 3, which are omitted for brevity. The processor of the user terminal is configured to provide computation and control capability to support the operation of the entire user terminal.

The display screen of the user terminal is configured to display, and the input device of the user terminal is configured to receive parameters such as parameter values such as the preset attributes associated with the identification of the insured person and inputted by the user. A person skilled in the art should understand, FIG. 6 is exemplary to show the structure relevant to the solution of the present disclosure and does not limit the user terminal to this embodiment of the present disclosure; the particular user terminal may include more or less components, be configured with other components not shown in the figure, or have a different configuration.

In one embodiment, a user terminal is provided, the user terminal includes a memory and one or more processors. The memory has computer-readable instructions stored thereon which when executed by the processor, cause one or more processes to perform the steps of the foregoing method of querying a status of an electronic insurance policy.

In an embodiment, it also provides one or more non-transitory computer-readable storage medium storing computer-readable instructions that, when executed by one or more processors, cause the one or more processors to perform the foregoing method of querying a status of an electronic insurance policy.

According to an example of the present embodiment, the storage medium includes but is not limited to a disk, a U disk, a CD, a Read-Only Memory (ROM) or a Random Access Memory (RAM) and so on.

In this embodiment, the initial status of the policy is queried according to the inputted policy number by the user, and according to the stored operation flow set of the policy and the creation time of the operation flow, the status subset queried in the status total set and belonging to the policy and the time of the corresponding operation flow that are displayed, so that the user can query the initial status, the intermediate status, and the latest status of the electronic insurance policy according to the policy number of the electronic insurance policy, so that the user can learn the status of the electronic insurance policy in real time and the creation times of various statuses, and the user experience is improved.

The different technical features of the above embodiments can have various combinations which are not described for the purpose of brevity. Nevertheless, to the extent the combining of the different technical features do not conflict with each other, all such combinations must be regarded as being within the scope of the disclosure.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall within the protection scope of the present disclosure. Therefore, the protection scope of the present disclosure shall be subject to the protection scope of the claims.

What is claimed is:

1. A method of querying a status of an electronic insurance policy comprising:
receiving an inputted insurance policy number;
querying an initial status and an operation flow set of the electronic insurance policy corresponding to the policy number when the policy number is a valid policy number;
obtaining a mapped status subset according to a status total set to which the initial status belongs and a status that each operation flow in the operation flow set is mapped in the status total set; and
displaying the initial status of the electronic insurance policy and the obtained status subset.

2. The method according to claim 1, wherein the method further comprises:
obtaining a creation time of the pre-stored initial status of the electronic insurance policy and a creation time of the pre-stored operation flow; and
correspondingly displaying the creation time of the operation flow and a status that the operation flow is mapped in the status total set, and correspondingly displaying the creation time of the initial status and the initial status.

3. The method according to claim 1, wherein the step of receiving the inputted policy number comprises:
scanning a barcode or a QR code carrying information of the policy number; and
regarding a policy number identified in the barcode or the QR code as the inputted policy number.

4. The method according to claim 1, wherein the method further comprises:
determining whether the operation flow set comprises a return; and
obtaining the mapped status subset according to the status that each operation flow in the operation flow set is mapped in the status total set, when the operation flow set does not comprise the return.

5. The method according to claim 1, wherein a status code indicating a corresponding status is preset for each status, and the status code is stored in the status total set; and the method further comprises:
obtaining a status subset of a mapped status code according to the status total set to which the status code of the initial status belongs and the status code that each operation flow in the operation flow set is mapped in the status total set; and
displaying a status represented by the status code in the obtained status subset.

6-10. (canceled)

11. A user terminal comprising one or more processors and a memory having computer-readable instructions stored therein that, when executed by the processor, cause the one or more processes to perform the following steps:
receiving an inputted policy number;
querying an initial status and an operation flow set of the electronic insurance policy corresponding to the policy number when the policy number is a valid policy number;
obtaining a mapped status subset according to a status total set to which the initial status belongs and a status that each operation flow in the operation flow set is mapped in the status total set; and
displaying the initial status of the electronic insurance policy and the obtained status subset.

12. The user terminal according to claim 11, wherein the processor further performs the following steps:
obtaining a creation time of the pre-stored initial status of the electronic insurance policy and a creation time of the pre-stored operation flow; and
correspondingly displaying the creation time of the operation flow and a status that the operation flow is mapped in the status total set, and correspondingly displaying the creation time of the initial status and the initial status.

13. The user terminal according to claim 11, wherein the step of receiving the inputted policy number performed by the processor comprises:
scanning a barcode or a QR code carrying information of the policy number; and
regarding a policy number identified in the barcode or the QR code as the inputted policy number.

14. The user terminal according to claim 11, wherein the processor further performs the following steps:
determining whether the operation flow set comprises a return; and
obtaining the mapped status subset according to the status that each operation flow in the operation flow set is mapped in the status total set, when the operation flow set does not comprise the return.

15. The user terminal according to claim 11, wherein a status code indicating a corresponding status is preset for each status, and the status code is stored in the status total set; and the processor further performs the following steps:
obtaining a status subset of a mapped status code according to the status total set to which the status code of the initial status belongs and the status code that each operation flow in the operation flow set is mapped in the status total set; and
displaying a status represented by the status code in the obtained status subset.

16. One or more non-transitory readable storage medium having computer-readable instructions stored thereon that, when executed by one or more processors, cause the one or more processors to perform the following steps:
receiving an inputted policy number;
querying an initial status and an operation flow set of the electronic insurance policy corresponding to the policy number when the policy number is a valid policy number;
obtaining a mapped status subset according to a status total set to which the initial status belongs and a status that each operation flow in the operation flow set is mapped in the status total set; and
displaying the initial status of the electronic insurance policy and the obtained status subset.

17. The storage medium according to claim 16, wherein the processor further performs the following steps:
obtaining a creation time of the pre-stored initial status of the electronic insurance policy and a creation time of the pre-stored operation flow; and
correspondingly displaying the creation time of the operation flow and a status that the operation flow is mapped in the status total set, and correspondingly displaying the creation time of the initial status and the initial status.

18. The storage medium according to claim 16, wherein the step of receiving the inputted policy number performed by the processor comprises:
scanning a barcode or a QR code carrying information of the policy number; and
regarding a policy number identified in the barcode or the QR code as the inputted policy number.

19. The storage medium according to claim 16, wherein the processor further performs the following steps:
determining whether the operation flow set comprises a return; and
obtaining the mapped status subset according to the status that each operation flow in the operation flow set is mapped in the status total set, when the operation flow set does not comprise the return.

20. The storage medium according to claim 16, wherein a status code indicating a corresponding status is preset for each status, and the status code is stored in the status total set; and the processor further performs the following steps:
obtaining a status subset of a mapped status code according to the status total set to which the status code of the initial status belongs and the status code that each operation flow in the operation flow set is mapped in the status total set; and
displaying a status represented by the status code in the obtained status subset.
